(19) United States
(12) Patent Application Publication
(10) Pub. No.: US 2025/0383293 A1
(43) Pub. Date: Dec. 18, 2025

(54) ANALYTICAL SYSTEM AND ANALYTICAL METHOD

(71) Applicant: NITTO DENKO CORPORATION, Ibaraki-shi, Osaka (JP)

(72) Inventors: Keine NISHIYAMA, Ibaraki-shi, Osaka (JP); Nobuyuki KOZONOI, Ibaraki-shi, Osaka (JP)

(21) Appl. No.: 19/108,251

(22) PCT Filed: Aug. 28, 2023
(86) PCT No.: PCT/JP2023/031024

§ 371 Date: Mar. 3, 2025

(30) Foreign Application Priority Data
Sep. 6, 2022 (JP) 2022-141145

(51) Int. Cl. G01N 21/80

(52) U.S. Cl. CPC G01N 21/80

(57) ABSTRACT

An analytical system includes a sensor having a plurality of detection parts including colorimetric reagents, and configured to detect a plurality of types of substances from a single specimen, and an analyzer having a processor and memory, configured to measure a concentration of at least one substance among the plurality of types of substances, wherein the analyzer includes a color information acquisition part configured to acquire color information indicating colors of the colorimetric reagents contained in the plurality of respective detection parts, and a concentration calculation part configured to calculate the concentration of the one substance by using the color information indicating a color of a colorimetric reagent contained in a detection part for detecting the one substance among the plurality of detection parts, and color information indicating a color of a colorimetric reagent contained in a detection part other than the detection part which detects the one substance.

### TECHNICAL FIELD

The disclosure herein relates to an analytical system and analytical method.

### BACKGROUND ART

Conventionally, a measurement method is known in which an image of a test unit, where a plurality of colorimetric reagents are arranged, is captured after the reagents have reacted with an analyte, and a concentration of the analyte is measured based on this captured image (Patent Literature (PTL) 1). In recent years, when the concentration of a substance contained in a solution is measured using a colorimetric reagent, it is known that a pH value of the solution affects a color change of the colorimetric reagent (Non-Patent Literature 1).

### CITATION LIST

### Patent Literature

PTL 1: Japanese Patent Application Publication No. 2017-53849

### Non-Patent Literature

Non-Patent Literatures 1: Y. Suenaga, et al., BUNSEKI KAGAKU 70, 165 (2021).

### SUMMARY OF THE INVENTION

### Problems to be Solved by the Invention

In the measurement method described in PTL 1, effect of a specimen's pH value on the color change of the reagent is not considered. Additionally, a technology described in Non-Patent Literature 1 does not clarify to what extent the solution's pH value is corrected. Furthermore, in the technology described in Non-Patent Literature 1, in order to reduce the effect of the pH value on the color of the colorimetric reagent, one additional pH adjustment layer needs to be added to a device, which increases a cost. Thus, it is difficult to improve accuracy of a measurement result of the concentration of the substance using the colorimetric reagent in conventional technologies.

In one aspect, an object is to improve the accuracy of the measurement result.

### Means of Solving the Problem

According to one embodiment, an analytical system includes a sensor having a plurality of detection parts including colorimetric reagents, and configured to detect a plurality of types of substances from a single specimen, and an analyzer configured to measure a concentration of at least one substance among the plurality of types of substances, wherein the analyzer includes a color information acquisition part configured to acquire color information indicating colors of the colorimetric reagents contained in the plurality of respective detection parts, and a concentration calculation part configured to calculate the concentration of the one substance by using the color information indicating a color of a colorimetric reagent contained in a detection part for detecting the one substance among the plurality of detection parts, and color information a color of a colorimetric reagent contained in a detection part other than the detection part which detects the one substance.

### Effects of the Invention

The object of the present invention is to improve the accuracy of measurement results.

### BRIEF DESCRIPTION OF THE DRAWINGS

FIG. 1 is a drawing illustrating an example of a system configuration of an analytical system of a first embodiment.

FIG. 2 is a drawing describing a sensor.

FIG. 3 is a drawing describing a relation between a pH value, a concentration of sodium ion, and a color of a reagent.

FIG. 4 is a drawing illustrating an example of a hardware configuration of the analyzer.

FIG. 5 is a drawing describing a functional configuration of the analyzer according to the first embodiment.

FIG. 6 is a drawing illustrating an example of training data in generating trained data.

FIG. 7 is a first flowchart describing processing of the analyzer according to the first embodiment.

FIG. 8 is a second flowchart describing the processing of the analyzer according to the first embodiment.

FIG. 9 is a drawing illustrating an example of a system configuration of an analytical system of a second embodiment.

FIG. 10 is a drawing describing a functional configuration of the analyzer according to the second embodiment.

FIG. 11A is a drawing illustrating an example of a guide screen.

FIG. 11B is a first drawing illustrating a display example of a determination result.

FIG. 11C is a second drawing illustrating the display example of the determination result.

### DESCRIPTION OF THE PREFERRED EMBODIMENTS

### First Embodiment

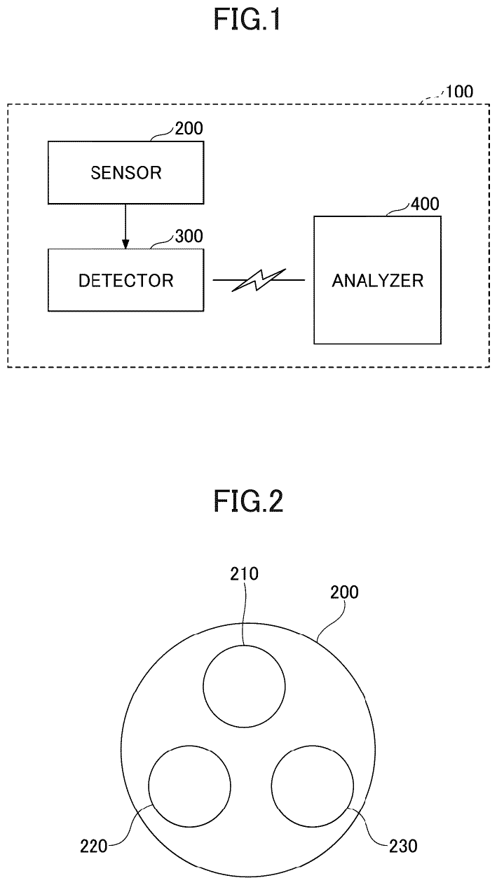

In the following, the present embodiment will be described with reference to the accompanying drawings. First, an analytical system of the present embodiment will be described with reference to FIG. 1.

FIG. 1 is a drawing illustrating an example of a system configuration of the analytical system of the first embodiment. The analytical system 100 of the present embodiment includes a sensor 200, a detector 300, and an analyzer 400.

In the sensor 200, a plurality of substrates infiltrated with a plurality of respective reagents of different types are arranged and sealed. The reagent is a colorimetric reagent whose color changes in response to a substance contained in a specimen, and the sensor 200 detects a plurality of types of substances and characteristics contained in the specimen by the color change of respective colorimetric reagents.

In the following description, a substrate infiltrated with the colorimetric reagent is referred to as a detection part. Therefore, the sensor 200 of the present embodiment has a plurality of detection parts including the colorimetric reagent, and is a sensor that detects a plurality of types of substances and characteristics in respective detection parts from a single specimen.

In the analytical system 100 of the present embodiment, one of the substances contained in the specimen is designated as a target substance, and the concentration of the target substance is measured. In the following description, the target substance whose concentration is to be measured among the substances contained in the specimen is referred to as a measurement target substance.

In the present embodiment, the specimen may be, for example, sweat or saliva collected from a human body. In the present embodiment, the measurement target substance is a sodium ion (Na⁺), which is one of electrolytes contained in the specimen, and the concentration of the measurement target substance is the concentration of sodium ion (Na⁺). The electrolyte may be a chloride ion (Cl⁻) in addition to the sodium ion (Na⁺).

The detector 300 of the present embodiment extracts color information indicating the color of respective detection parts of the sensor 200. In other words, the detector 300 extracts color information indicating the color of the reagent infiltrated into the substrate arranged in the sensor 200.

The color information in the present embodiment may be, for example, an RGB value (R, G, and B values). Specifically, the detector 300 of the present embodiment may be, for example, an imaging device or a spectroscope. The detector 300 of the present embodiment may be any device as long as it can detect color information indicating the color of the reagent.

The analyzer 400 of the present embodiment acquires color information of respective detection parts of the sensor 200 from the detector 300, calculates the concentration of the measurement target substance from the color information, and outputs it as a measurement result.

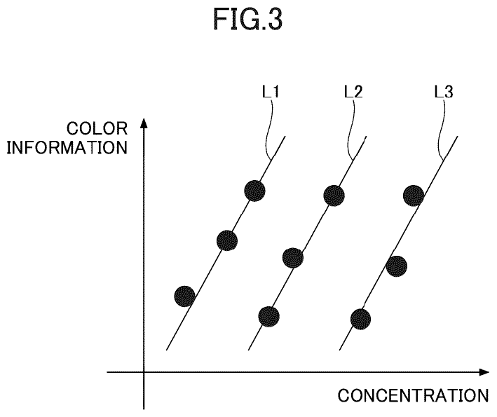

The sensor 200 in the present embodiment will now be described with reference to FIG. 2.

FIG. 2 is a drawing describing a sensor. The sensor 200 in the present embodiment has a detection part 210, a detection part 220, and a detection part 230. Each of the detection part 210, detection part 220, and detection part 230 may be a substrate infiltrated with a reagent. The substrate may be, for example, filter paper or nonwoven fabric.

In the sensor 200, the detection part 210, detection part 220, and detection part 230 may be enclosed with a transparent member, and an inflow path may be provided for the specimen to reach the detection parts 210, 220, and 230.

In the present embodiment, the reagent included in the detection part 210 may change color according to the pH value of the specimen, and the reagent included in the detection part 220 may change color according to the concentration of sodium ion (Na⁺). The reagent included in the detection part 230 may change color according to the detection of amino acids. The amino acids include, for example, valine, leucine, isoleucine, and the like.

The number of detection parts included in the sensor 200 is not limited to three shown in FIG. 2, but may be any number. In other words, the number of types of reagents included in the sensor 200 is not limited to three.

The sensor 200 may include detection parts (reagents) whose color changes depending on, for example, lactic acid, uric acid, protein, lipid, ketone, hormone, mRNA, iron, and the like.

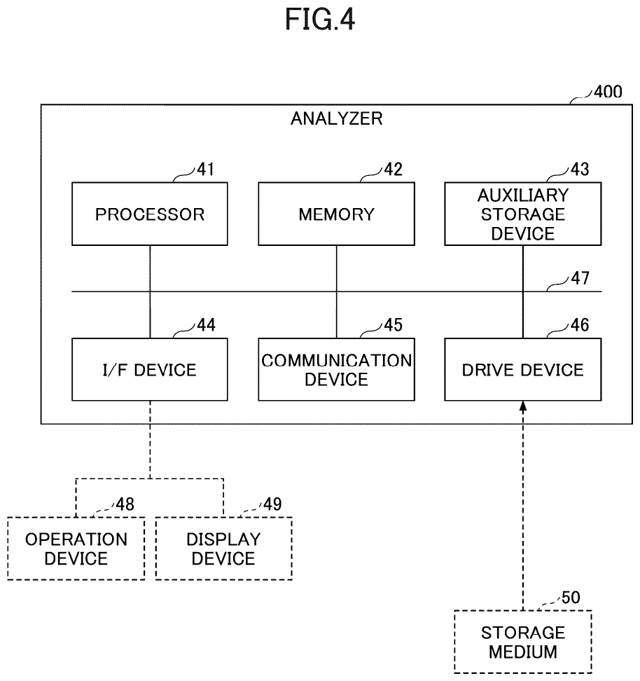

Next, a calculation of the concentration of the measurement target substance will be described with reference to FIG. 3. In the following embodiments, a case where sodium ions are used as a measurement target substance will be described.

FIG. 3 is a drawing describing a relation between a pH value, a concentration of sodium ion, and a color of a reagent. In FIG. 3, the horizontal axis indicates the concentration of sodium ions contained in the specimen, and the vertical axis indicates the color information of the reagent for detecting sodium ions.

A line L1 shown in FIG. 3 shows the relation between the concentration of sodium ions and color information indicating the color of the reagent that reacts with sodium ions when the pH value of the specimen is X1, the line L2 shows the relation between the concentration of sodium ions and color information indicating the color of the reagent that reacts with sodium ions when the pH value of the specimen is X2, and the line L3 shows the relation between the concentration of sodium ions and color information indicating the color of the reagent that reacts with sodium ions when the pH value of the specimen is X3.

Here, when X1<X2<X3, the concentration of sodium ions tends to increase as the pH value rises, even if the color information remains the same value.

That is, a way the color of the reagent that reacts with sodium ions changes has a correlation with the pH value of the specimen.

Therefore, even if the RGB value (color information) indicating the color of the reagent that reacts with sodium ion remains same, the concentration of sodium ion is different when the pH value of the specimen is X1, X2, or X3.

In the present embodiment, focusing on this point, the concentration of sodium ion is calculated by considering the effect of the pH value of the specimen on the color of the reagent that reacts with sodium ion.

Specifically, in the present embodiment, the concentration of sodium ion is measured using color information indicating the color of the detection part 210 that detects the pH value of the specimen and color information indicating the color of the detection part 220 that detects sodium ion.

In the present embodiment, influence of the pH value of the specimen on the color change of the reagent that reacts with sodium ion can be excluded, and the accuracy of the measurement result can be improved.

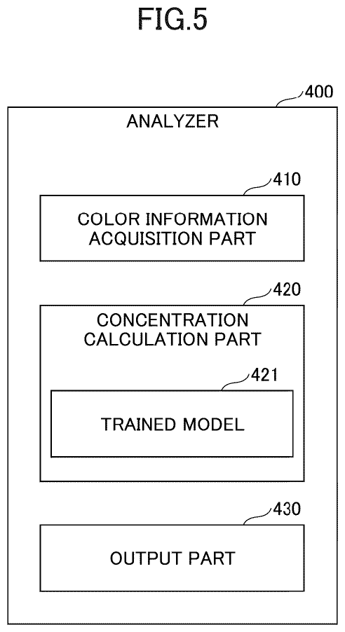

The analyzer 400 of the present embodiment will be described below. FIG. 4 is a drawing illustrating an example of a hardware configuration of the analyzer.

The analyzer 400 of the present embodiment includes a processor 41, a memory 42, an auxiliary storage device 43, an interface (I/F) device 44, a communication device 45, and a drive device 46. The hardware of the analyzer 400 is connected to each other via a bus 47.

The processor 41 includes various computing devices such as a CPU (Central Processing Unit) and a GPU (Graphics Processing Unit). The processor 41 reads and executes various programs (for example, a learning program) on the memory 42.

The memory 42 includes main storage devices such as ROM (Read Only Memory) and RAM (Random Access Memory). The processor 41 and the memory 42 form what is called a computer, and the processor 41 executes various programs read on the memory 42 to achieve functions of the analyzer 400 described later.

The auxiliary storage device 43 stores various programs and various data used when the various programs are executed by the processor 41.

The I/F device 44 is a connection device for connecting an operation device 48 and a display device 49, which are examples of external devices, to the analyzer 400. The I/F device 44 receives an operation for the analyzer 400 through the operation device 48. The I/F device 44 may output a result of the processing by the analyzer 400 and display it to a manager of the analyzer 400 through the display device 49.

The communication device 45 is a communication device for communicating with other devices (in the present embodiment, the detector 300).

The drive device 46 is a device for setting a storage medium 50. The storage medium 50 includes a medium for recording information optically, electrically, or magnetically, such as a CD-ROM, flexible disk, magneto-optical disk, or the like. The storage medium 50 may also include a semiconductor memory for recording information electrically, such as a ROM, flash memory, or the like.

Various programs installed in the auxiliary storage device 43 are installed, for example, when a distributed storage medium 50 is set in the drive device 46, and various programs recorded in the storage medium 50 are read by the drive device 46. Alternatively, various programs installed in the auxiliary storage device 43 may be downloaded from a network via the communication device 45.

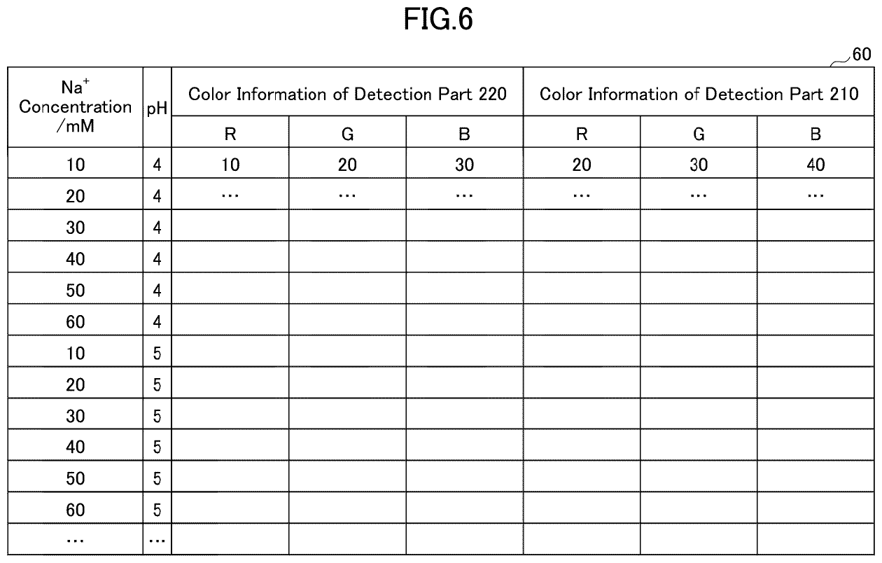

Next, referring to FIG. 5, functions of the analyzer 400 of the present embodiment will be described. FIG. 5 is a drawing describing a functional configuration of the analyzer according to the first embodiment.

The analyzer 400 of the present embodiment has a color information acquisition part 410, a concentration calculation part 420, and an output part 430.

The color information acquisition part 410 of the present embodiment acquires color information extracted by the detector 300 from each of the detection parts 210, 220, and 230 of the sensor 200.

When the detector 300 is an imaging device, for example, the color information in the present embodiment may be an RGB value of the image of each detection part extracted from image data indicating the image of the sensor 200 captured after the reagent included in the detection parts 210, 220, and 230 reacted with the specimen.

Moreover, when the detector 300 is an imaging device, the color information may include luminance indicating brightness of the image of respective detection parts and color differences.

The concentration calculation part 420 calculates the concentration of the measurement target substance using, for example, the color information acquired by the color information acquisition part 410.

Specifically, the concentration calculation part 420 in the present embodiment has a trained model 421. In other words, the concentration calculation part 420 may be a storage part that holds the trained model 421.

The trained model 421 of the present embodiment is a model generated by performing machine learning using training data prepared in advance, and when the color information of the detection part 210 and the color information of the detection part 220 are input, the pH value of the specimen and the concentration of sodium ions are output. Details of the training data of the trained model 421 will be described later.

The concentration calculation part 420 of the present embodiment inputs the color information acquired by the color information acquisition part 410 to the trained model 421, and acquires the concentration of the measurement target substance output from the trained model 421 as the measurement result.

In the present embodiment, the concentration calculation part 420 acquires the result of measuring the concentration of the measurement target substance using the trained model 421, but the concentration calculation part 420 may acquire the result of measuring the concentration of the measurement target substance by another method. Specifically, when the relation between the color of the reagent and the concentration is expressed by a simple regression equation, the concentration calculation part 420 may use this regression equation, and the trained model 421 is not required to be used.

The output part 430 outputs the concentration of the measurement target substance calculated by the concentration calculation part 420.

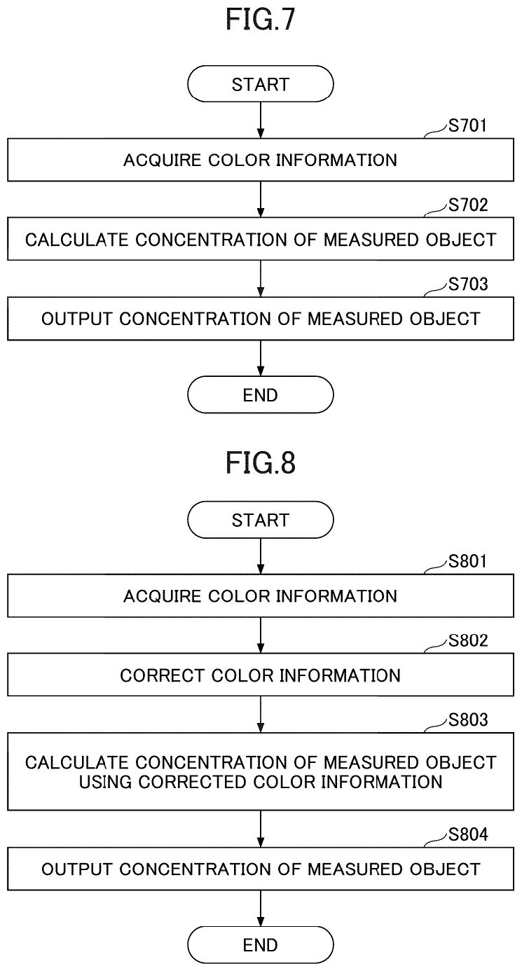

Hereinafter, the trained model 421 of the present embodiment will be described with reference to FIG. 6. FIG. 6 is a drawing illustrating an example of training data in generating trained data.

The training data 60 shown in FIG. 6 is a data set in which the color information of the detection part 210 and the color information of the detection part 220 are input data, and the pH value of the specimen and the concentration of sodium ions are output data.

The color information of the detection part 210 is color information indicating the color of the reagent included in the detection part 210, and the color information of the detection part 220 is color information indicating the color of the reagent included in the detection part 220. The color information of the detection part 210 and the color information of the detection part 220 include RGB values.

The trained model 421 of the present embodiment is a trained model generated by machine learning using the training data shown in FIG. 6, and when the color information of the detection part 210 and the color information of the detection part 220 are input, it outputs the concentration of sodium ions and the pH value corresponding to a combination of the color information.

The trained model 421 of the present embodiment may be generated by the analyzer 400, or may be generated by a device other than the analyzer 400.

When the trained model 421 is generated in the analyzer 400, a learning part may be provided in the analyzer 400, and machine learning using the training data 60 may be performed to generate the trained model 421 as a pre-processing of the processing described later.

In the example of FIG. 6, the training data 60 is a data set in which color information of two types of reagents and two types of values corresponding to the two types of reagents are associated with each other, but this is not limited to this. For example, the training data 60 may be a data set in which color information of three or more types of reagents and three or more types of values corresponding to the respective three or more types of reagents are associated with each other.

When the trained model 421 is generated by machine learning using such training data, even if the sensor 200 includes three or more detection parts, the color information of reagents included in each detection part may be input to the trained model 421 to acquire values corresponding to the respective reagents included in the respective detection parts.

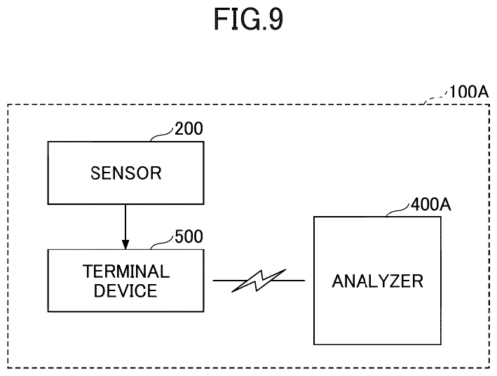

Next, with reference to FIG. 7, the processing of the analyzer 400 of the present embodiment will be described. FIG. 7 is a first flowchart describing processing of the analyzer according to the first embodiment.

The analyzer 400 of the present embodiment acquires the color information of respective detection parts of the sensor 200 extracted by the detector 300 by the color information acquisition part 410 (step S701). The analyzer 400 and the detector 300 may be connected by wireless communication, for example, and the color information may be acquired by the analyzer 400 by communication.

Subsequently, the analyzer 400 calculates the concentration of the measurement target substance by the concentration calculation part 420 using the color information acquired in step S701 (step S702).

Subsequently, the analyzer 400 outputs the concentration of the measurement target substance acquired by the concentration calculation part 420 by the output part 430 (step S703).

The processing of FIG. 7 will be specifically described below. In the following description, the detector 300 will be described as an imaging device.

In the sensor 200, when a specimen reaches each of the detection parts 210, 220, and 230, the color of the reagent contained in each detection part changes. The detector 300 picks up the image data of the sensor 200 after the color of the reagent contained in the detection parts 210, 220, and 230 has changed.

The color information acquisition part 410 of the analyzer 400 acquires image data from the detector 300, and identifies images of the detection parts 210, 220, and 230 from the images indicated by the acquired image data. Specifically, for example, the color information acquisition part 410 may identify a circular image contained in the image of the sensor 200 as the image of each detection part.

Subsequently, the color information acquisition part 410 extracts color information from the identified image. Specifically, the color information acquisition part 410 may extract the RGB value, luminance, color difference, etc. of the identified image as color information.

When the color information acquisition part 410 acquires the color information of the detection parts 210, 220, and 230, the analyzer 400 inputs the color information to the trained model 421 by the concentration calculation part 420 to acquire the pH value and the concentration of sodium ions output from the trained model 421.

At this time, the color information to be input to the trained model 421 is not required to include the color information of the detection part 230. In the present embodiment, the color information of the detection part 210 and the color information of the detection part 220 may be input to the trained model 421.

In the present embodiment, the trained model 421 may output only the concentration of sodium ions as a value of the measurement target substance, and is not required to output the pH value. In this case, for example, when the color information is input to the trained model 421, the information specifying the measurement target substance may be input to the trained model 421 together with the color information.

In the above description, the image data is acquired from the detector 300, and the color information of the detection parts 210, 220, and 230 is extracted by the analyzer 400, but this is not limited thereto. The extraction of the color information may be performed by the detector 300.

In above the description, the color information of the detection parts 210, 220, and 230 is extracted based on the image data of the sensor 200, and the extracted color information is input to the trained model 421, but this is not limited thereto.

In the present embodiment, the image data captured by the detector 300 may be input to the trained model 421 as it is. In this case, the trained model 421 may extract the color information from the input image data.

Thus, in the present embodiment, when measuring the concentration of the measurement target substance contained in the specimen, the concentration of the measurement target substance is acquired by using the color information of the reagent after reacting with the measurement target substance contained in the specimen and the color information of the reagent after reacting with a substance other than the measurement target substance contained in the specimen or characteristics of the specimen.

More specifically, in the present embodiment, when the concentration of sodium ions contained in the specimen is measured using the sensor 200, the concentration of sodium ions is measured using color information of the reagent that reacts with sodium ions and color information of the reagent that reacts with the pH value of the specimen.

Therefore, according to the present embodiment, the influence of the pH value of the specimen on the color of the reagent that reacts with sodium ions can be excluded, and the measurement accuracy of the concentration of sodium ions output as a measurement result can be improved.

### Variation

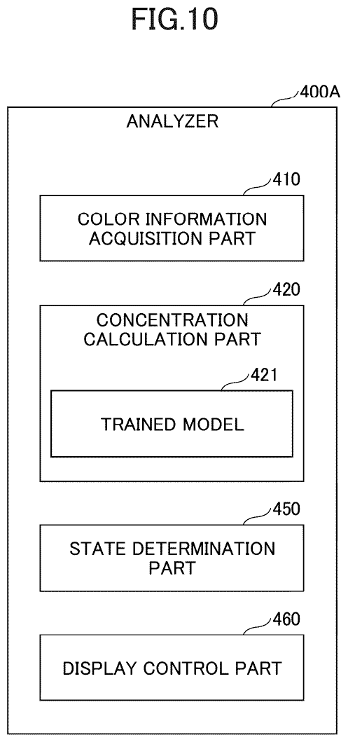

A variation of the present embodiment will be described below with reference to FIG. 8. In the variation, when the detector 300 is an imaging device, before extracting color information from the image data captured by the detector 300, correction is performed to reduce the influence of the external environment from the image data.

A variation of the present embodiment will be described below with reference to FIG. 8. FIG. 8 is a second flowchart describing the processing of the analyzer according to the first embodiment.

The analyzer 400 of the present embodiment acquires color information of the detection parts 210, 220, and 230 included in the sensor 200 from the detector 300 by the color information acquisition part 410 (step S801). Specifically, the color information acquisition part 410 extracts color information of the detection parts 210, 220, and 230 based on the image data acquired from the detector 300.

Subsequently, the analyzer 400 corrects the extracted color information by the concentration calculation part (step S802). 420 A correction performed here is, for example, a correction performed by the concentration calculation part 420 to prevent the effect of the environment when the image is captured on the color, and may be a correction using a predetermined reference color.

The environment when the image is captured indicates, for example, an angle of the detector 300 when the image is captured, a distance from the sensor 200 to the detector 300, and illuminance and color temperature of ambient lighting and external light when the image is captured.

Subsequently, the concentration calculation part 420 calculates the concentration of the measurement target substance using the corrected color information (step S803). Specifically, the concentration calculation part 420 inputs the corrected color information to the trained model 421, and acquires the concentration of the measurement target substance output from the trained model 421 as the measurement result. Subsequently, the analyzer 400 outputs the concentration of the measurement target substance by the output part 430 (step S804).

Thus, in the variation, by correcting the color information before the color information is input to the trained model 421, it is possible to exclude the influence of the environment when the image data of the detection part included in the sensor 200 is acquired on the color information of the detection parts 210, 220, and 230, and to improve the accuracy of the measurement result.

In the above-described example, the correction of the color information is performed by the analyzer 400, but the correction of the color information, which is not limited thereto, may be performed by the detector 300. In this case, since the color information acquisition part 410 acquires the corrected color information from the detector 300, the correction of the color information need not be performed by the analyzer 400.

### Second Embodiment

The second embodiment will be described below with reference to the drawings. The second embodiment differs from the first embodiment in that a terminal device is used instead of the detector 300 and information acquired according to the measurement result is output to the terminal device. Therefore, in the following description of the second embodiment, the differences from the first embodiment will be explained, and the same reference numerals as those used in the description of the first embodiment will be assigned to functional configurations similar to those of the first embodiment, and the description thereof will be omitted.

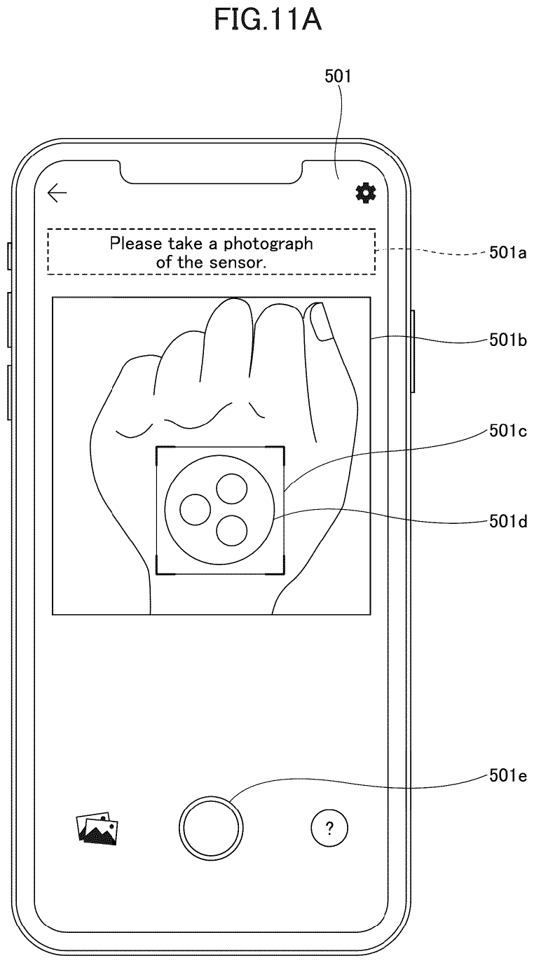

FIG. 9 is a drawing illustrating an example of a system configuration of an analytical system of a second embodiment.

The analytical system 100A of the present embodiment includes a sensor 200, a terminal device 500, and an analyzer 400A.

In the analytical system 100A of the present embodiment, the terminal device 500 and the analyzer 400A are connected via a network such as the Internet. The analyzer 400A of the present embodiment may be, for example, a server device provided on the Internet.

The terminal device 500 of the present embodiment is a portable computer having an imaging device, specifically, a smartphone or a tablet type terminal device.

In the present embodiment, the sensor 200 may be attached to, for example, the skin of a user of the terminal device 500. In the present embodiment, an image of the sensor 200 attached to a human body may be captured by the imaging device of the terminal device 500. In other words, the user of the terminal device 500 is a user of the analytical system 100A.

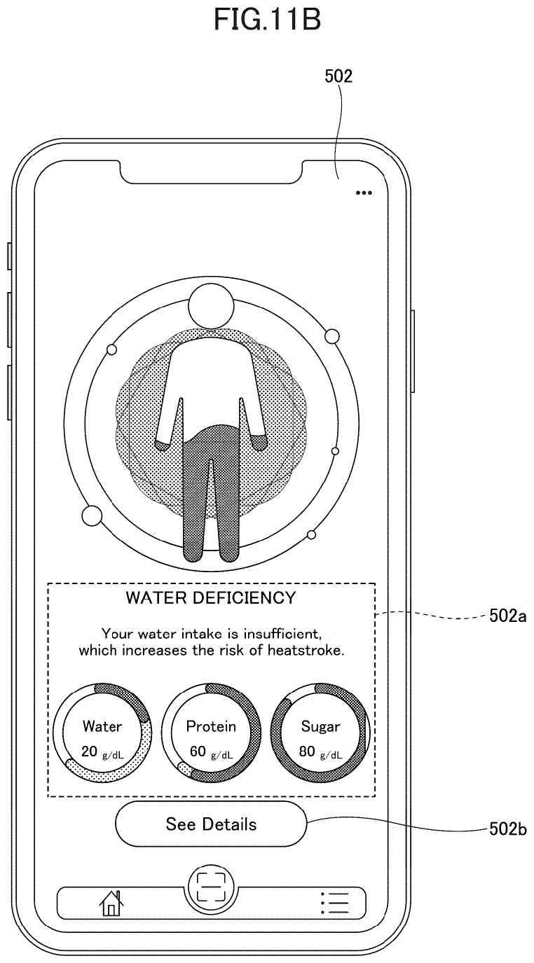

Next, a function of the analyzer 400A of the present embodiment will be described with reference to FIG. 10. FIG. 10 is a drawing describing a functional configuration of the analyzer according to the second embodiment.

The analyzer 400A of the present embodiment includes a color information acquisition part 410, a concentration calculation part 420, a state determination part 450, and a display control part 460.

The state determination part 450 determines the state of the user of the terminal device 500 using the concentration of the measurement target substance calculated by the concentration calculation part 420. Specifically, the state determination part 450 may determine, for example, an amount of water, which is one of items indicating the state of the user of the terminal device 500. In other words, the state determination part 450 may determine whether the user of the terminal device 500 is in a state of insufficient water.

In addition, the state determination part 450 of the present embodiment may determine, among the items indicating the state of the user of the terminal device 500, items for which the state can be determined by using the characteristics and concentration, and the like, of the specimen detected by the reagent included in the detection part of the sensor 200. In other words, the state determination part 450 can determine the state of the source of the specimen by using characteristics and concentration of the specimen detected by the reagent included in the detection part of the sensor 200.

The display control part 460 causes the terminal device 500 to display a screen corresponding to the result of the determination by the state determination part 450.

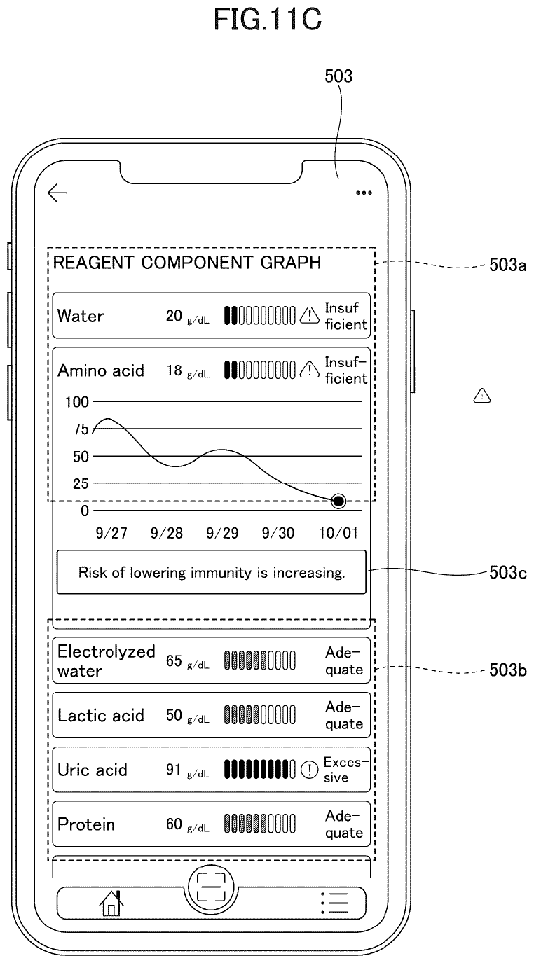

A display example of the terminal device 500 will be described below with reference to FIG. 11. FIGS. 11A, 11B, and 11C are drawings illustrating display examples of the terminal device.

The screen 501 shown in FIG. 11A is an example of a guide screen for capturing an image of the sensor 200, the screen 502 shown in FIG. 11B is a first drawing showing a display example of a determination result by the state determination part 450, and the screen 503 shown in FIG. 11C is a second drawing showing a display example of a determination result by the state determination part 450.

The screen 501 includes display areas 501a, 501b, and an operation button 501e. The display area 501a displays a message prompting the user of the terminal device 500 to capture an image of the sensor 200. The display area 501b displays a guide image 501c for capturing an image of the sensor 200. In the example of FIG. 11A, the display area 501b is in a state where the image 501d of the sensor 200 is placed in the area indicated by the guide image 501c.

The operation button 501e is an operation button for instructing the image data of the image displayed in the display area 501b to be captured.

When the operation button 501e is operated in the state shown in FIG. 11A, the terminal device 500 captures the image displayed in the display area 501b and transmits it to the analyzer 400A as image data.

The screen 502 shown in FIG. 11B includes a display area 502a and an operation button 502b. The display area 502a displays the determination result of the state determination part 450. The operation button 502b is an operation button for displaying a detailed screen of the determination result of the state determination part 450.

In the example shown in FIG. 11B, the display area 502a displays the result of determining whether the state of the user of the terminal device 500 is insufficient in water content. Specifically, a message indicating that the water content is insufficient is displayed in the display area 502a.

In addition, the value of the substance detected from the specimen by the detection part of the sensor 200 may be displayed in the display area 502a.

In the example of FIG. 11B, the concentration of protein, concentration of sugar, and the like are displayed in the display area 502a as values of the substances detected by the sensor 200.

When the operation button 502b is operated in the screen 502, the screen 502 displayed on the terminal device 500 transitions to the screen 503 shown in FIG. 11C.

The screen 503 shown in FIG. 11C includes display areas 503a, 503b, and 503c. The display areas 503a and 503b display a history of values measured using the sensor 200 in the past, a list of values detected by the detection part of the sensor 200, and the like. In addition, the display areas 503a and 503b may display the determination result of whether or not the value the measured by sensor 200 is appropriate.

The display area 503c displays a message indicating the state of the user of the terminal device 500 determined from the values displayed in the display areas 503a and 503b.

In the example of FIG. 11C, the display area 503a displays the transition of the concentration of the amino acids detected in the past. In addition, the display area 503b displays a list in which the substance whose concentration is measured by the sensor 200 is associated with the concentration of the substance which is the measurement result. Furthermore, in the example of FIG. 11C, the display area 503b displays the determination result of determining whether or not the concentration of each substance whose concentration is measured is appropriate as the concentration in the specimen (sweat) collected from the human body.

This determination result may be, for example, the result of determining whether or not the concentration is appropriate based on a threshold of the concentrations of the respective substances predetermined by the state determination part 450.

In addition, in the display area 503c shown in FIG. 11C, a message informing the user of the terminal device 500 that the state of the user's immune system is weakened is displayed. The state of the user may be determined according to the concentrations of the substances displayed in the display areas 503a and 503b, the transition of the concentrations of the substances from the past to the present, and the like.

Thus, in the present embodiment, it is possible to collect a specimen from the user of the terminal device 500 by simply attaching the sensor 200 to the user. In addition, in the present embodiment, the state of the user at that time can be determined using the specimen collected from the user, and the result of the determination can be notified to the user, so that the user can easily grasp the user's own state.

In the present embodiment, the specimen is collected from a human body, but this is not the only possible source. The specimen can be collected from any source that is capable of providing a specimen that can reach the detection part of the sensor 200.

In each of the above-described embodiments, the concentration calculation part 420 calculates the concentration of the measurement target substance by inputting the color information of the plurality of detection parts acquired by the color information acquisition part 410 into the trained model 421, but this is not limited thereto.

For example, the concentration calculation part 420 may calculate the concentration of the measurement target substance by a method other than the method using the trained model 421 based on the color information of the plurality of detection parts acquired by the color information acquisition part 410.

Further, the present invention is not limited to the embodiments mentioned above, but various variations and modifications may be made without departing from the scope of the present invention.

The present application is based on and claims priority to Japanese patent application No. 2022-141145 filed on Sep. 6, 2022, with the Japanese Patent Office, and the entire contents of Japanese patent application No. 2022-141145 are hereby incorporated by reference.

### EXPLANATION OF REFERENCE NUMERALS

100, 100A analytical system
200 sensor
210, 220, 230 detection part
300 detector
400, 400A analyzer
410 color information acquisition part
420 concentration calculation part
421 trained model
430 output part
450 state determination part
460 display control part
500 terminal device

1. An analytical system comprising:
a sensor having a plurality of detection parts including colorimetric reagents, and configured to detect a plurality of types of substances from a single specimen; and
an analyzer having a processor and memory, configured to measure a concentration of at least one substance among the plurality of types of substances,
wherein the analyzer includes:
a color information acquisition part configured to acquire color information indicating colors of the colorimetric reagents contained in the plurality of respective detection parts; and
a concentration calculation part configured to calculate the concentration of the one substance by using the color information indicating a color of a colorimetric reagent contained in a detection part for detecting the one substance among the plurality of detection parts, and color information indicating a color of a colorimetric reagent contained in a detection part other than the detection part which detects the one substance.

2. The analytical system according to claim 1, wherein the color information acquisition part is configured to acquire image data of the sensor from an imaging device which has captured an image of the sensor, and extract the color information for the plurality of detection parts from the image data.

3. The analytical system according to claim 2, wherein the concentration calculation part is a trained model whose input data is color information of the plurality of detection parts acquired by the color information acquisition part, and whose output data is a concentration of the one substance.

4. The analytical system according to claim 3, wherein the plurality of detection parts include a detection part configured to detect a pH value of the specimen.

5. The analytical system according to claim 4, wherein the input data includes the color information of the detection part for detecting a pH of the specimen, and the color information of the detection part for detecting the one substance.

6. An analytical method by an analytical system having a sensor having a plurality of detection parts including colorimetric reagents and configured to detect a plurality of types of substances from a single specimen, and an analyzer having a processor and memory, configured to measure a concentration of at least one substance among the plurality of types of substances, the method being performed by the analyzer and comprising;
acquiring color information indicating a color of a colorimetric reagent contained in the plurality of respective detection parts; and
calculating the concentration of the one substance by using color information indicating a color of a colorimetric reagent contained in a detection part which detects the one substance in the plurality of detection parts, and color information indicating a color of a colorimetric reagent contained in a detection part other than the detection part which detects the one substance in the plurality of detection parts.
